(19) United States
(12) Patent Application Publication
(10) Pub. No.: US 2022/0391986 A1
(43) Pub. Date: Dec. 8, 2022

(54) Fantasy Investment Gaming System and Method of Using Same

(71) Applicant: Michael Cameron Joyner, New Bern, NC (US)

(72) Inventor: Michael Cameron Joyner, New Bern, NC (US)

(21) Appl. No.: 17/829,840

(22) Filed: Jun. 1, 2022

Related U.S. Application Data
(60) Provisional application No. 63/208,048, filed on Jun. 8, 2021.

(51) Int. Cl. G06Q 40/06

(52) U.S. Cl. CPC G06Q 40/06

(57) ABSTRACT

A fantasy investment gaming system and method of using same. The fantasy investment gaming system may include a memory configured to store a set of instructions; and a processor configured to execute the set of instructions. The set of instructions may include generating one or more fantasy investment gaming leagues; providing access to the one or more fantasy investment gaming leagues to a plurality of authorized users, wherein each of the authorized users selects at least one of the one or more fantasy investment gaming leagues to join; providing a list of available investments to the plurality of authorized users; receiving and tracking market data of the selected available investments from a market data source over a predetermined time period; analyzing the market data; and determining, at the end of the predetermined time period, which of the selected fantasy lineups performed the best based on a predefined criteria and time period.

### RELATED APPLICATIONS

This application is related and claims priority to U.S. Provisional Patent Application Ser. No. 63/208,048, filed Jun. 8, 2021, the disclosure of which is incorporated herein by reference in its entirety.

### TECHNICAL FIELD

The subject matter of the invention relates generally to fantasy gaming systems and more particularly to a fantasy investment gaming system and method of using same.

### BACKGROUND

A fantasy sport is a type of game, often played using the Internet, where participants assemble imaginary or virtual teams composed of proxies of real players of a professional sport. These teams compete based on the statistical performance of those players in actual games. This performance is converted into points that are compiled and totaled according to a roster selected by each fantasy team's manager. These point systems can be simple enough to be manually calculated by a “league provider” (or commissioner) who coordinates and manages the overall league, or points can be compiled and calculated using computers tracking actual results of the professional sport. In fantasy sports, team owners draft, trade, and drop players, analogously to real sports.

Outside of sports, virtual/simulation tools exist related to investing and/or financial markets. However, these tools are not generally competitive games played for fun and/or money. Mainly, virtual investment tools are directed toward teaching a user to learn about how investing and financial markets work and how to invest without risking any hard-earned cash.

### SUMMARY

In one embodiment, a fantasy investment gaming system is provided. The fantasy investment gaming system may include a memory configured to store a set of instructions; and a processor configured to execute the set of instructions. The set of instructions may include generating one or more fantasy investment gaming leagues; providing access to the one or more fantasy investment gaming leagues to a plurality of authorized users, wherein each of the authorized users selects at least one of the one or more fantasy investment gaming leagues to join; generating and providing one or more lists of available investments to the plurality of authorized users, wherein the one or more lists of available investments are based on the selected one or more fantasy investment gaming leagues joined by the plurality of authorized users, and wherein each of the authorized users select a fantasy lineup comprising one or more investments from the one or more lists of available investments corresponding to the one or more fantasy investment gaming leagues they joined; automatically receiving and tracking market data of the selected available investments from at least one market data source over a predetermined time period; analyzing the market data; and determining, at the end of the predetermined time period, for each of the one or more fantasy investment gaming leagues, which of the selected fantasy lineups performed the best based on a predefined criteria over the predetermined time period. The market data may include financial market data. The market data may be automatically provided to the fantasy investment gaming system at predetermined time intervals by the market data source. The market data may be automatically provided by the at least one market data source to the fantasy investment gaming system in real time. The available investments may include one or more of publically traded securities, commodities, and/or currencies. The available investments may include publically traded companies. The predefined criteria may include financial performance of the investments of the selected fantasy lineups. During the predetermined time period the performance of each of the selected fantasy lineups may be automatically updated in real-time based on the received market data and compared, based on the predefined criteria, to the other selected fantasy lineups within its fantasy investment gaming leagues. The authorized users may monitor (and/or be notified of) the performance of their selected fantasy lineups in real-time during the predetermined time period, and may further monitor the performance of their selected fantasy lineups in comparison to other selected fantasy lineups in their in the one or more fantasy investment gaming leagues they joined, in real-time during the predetermined time period.

In another embodiment, a method of conducting a fantasy investment game is provided. The method may include generating one or more fantasy investment gaming leagues; providing access to the one or more fantasy investment gaming leagues to a plurality of authorized users; selecting by the plurality of authorized users at least one of the one or more fantasy investment gaming leagues to join; generating and providing one or more lists of available investments to the plurality of authorized users, wherein the one or more lists of available investments may be based on the selected one or more fantasy investment gaming leagues joined by the plurality of authorized users, and wherein each of the authorized users select a fantasy lineup comprising one or more investments from the one or more lists of available investments corresponding to the one or more fantasy investment gaming leagues they joined; receiving and tracking market data of the selected available investments from at least one market data source over a predetermined time period; analyzing the market data; and determining at the end of the predetermined time period, for each of the one or more fantasy investment gaming leagues, which of the selected fantasy lineups performed the best based on a predefined criteria over the predetermined time period. The market data may include financial market data. The market data may be automatically provided to the fantasy investment gaming system at predetermined time intervals by the market data source. The market data may be automatically provided by the at least one market data source to the fantasy investment gaming system in real time. The available investments may include one or more of publically traded securities, commodities, and/or currencies. The available investments may include publically traded companies. The predefined criteria may include financial performance of the investments of the selected fantasy lineups. During the predetermined time period the performance of each of the selected fantasy lineups may be automatically updated in real-time based on the received market data and compared, based on the predefined criteria, to the other selected fantasy lineups within its fantasy investment gaming leagues. The authorized users may monitor (and/or be notified of) the performance of their selected fantasy lineups in real-time during the predetermined time period, and may further monitor the performance of their selected fantasy lineups in comparison to other selected fantasy lineups in their in the one or more fantasy investment gaming leagues they joined, in real-time during the predetermined time period.

### BRIEF DESCRIPTION OF THE DRAWINGS

Having thus described the subject matter of the invention in general terms, reference will now be made to the accompanying drawings, which are not necessarily drawn to scale, and wherein:

FIG. 1 illustrates a block diagram of an example of a fantasy investment gaming system, in accordance with an embodiment of the invention;

FIG. 2 illustrates an example graphic of an example of a fantasy investment mobile app of the fantasy investment gaming system, in accordance with an embodiment of the invention;

FIG. 3 illustrates a flow diagram of an example of a method of using the fantasy investment gaming system, in accordance with an embodiment of the invention; and

FIG. 4 through FIG. 14 illustrate example screenshots of an example of a fantasy investment app or mobile app of the fantasy investment gaming system, in accordance with an embodiment of the invention.

### DETAILED DESCRIPTION

The subject matter of the invention now will be described more fully hereinafter with reference to the accompanying drawings, in which some, but not all embodiments of the subject matter of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the subject matter of the invention set forth herein will come to mind to one skilled in the art to which the subject matter of the invention pertains having the benefit of the teachings presented in the foregoing descriptions and the associated Drawings. Therefore, it is to be understood that the subject matter of the invention is not to be limited to the specific embodiments disclosed and that modifications and other embodiments are intended to be included within the scope of the appended claims.

In some embodiments, the subject matter of the invention provides a fantasy investment (e.g., publically tradeable securities, commodities, currencies, and the like) gaming system and method of using same.

In some embodiments, the fantasy investment gaming system and method may provide a fantasy investment gaming system in a networked computing configuration that may include a fantasy investment gaming application and a data store running on an application server, as well as a fantasy investment mobile app running on a user device. In some embodiments, the fantasy investment gaming system and method may provide a fantasy investment gaming system that may include one or more fantasy investment gaming providers.

In some embodiments, the fantasy investment gaming system and method may provide a fantasy investment gaming application that may be informed by one or more financial market sources (e.g., a securities exchange).

In some embodiments, the fantasy investment gaming system and method may provide a means of using investments, such as, but not limited to, publically traded companies, securities, commodities, currencies and/or other publicly tradeable investments, in a fantasy gaming format that allows players to compete, draft, and manage investments in a game of skill.

In some embodiments, the fantasy investment gaming system and method may provide a fantasy investment gaming system in which scoring of fantasy investment games may be based, for example, on percentages and/or monetary increases and/or decreases of each investment, e.g., a company's stock performance.

In some embodiments, the fantasy investment gaming system and method may be structured with a traditional fantasy timeline format (i.e., a season-like format), such as daily gaming, weekly, monthly, and yearly “season-like” formats of game length.

In some embodiments, the fantasy investment gaming system and method may be structured to provide a game of skill using 1-on-1 competition and/or multi-players competition.

Further, a method of using the fantasy investment gaming system is provided.

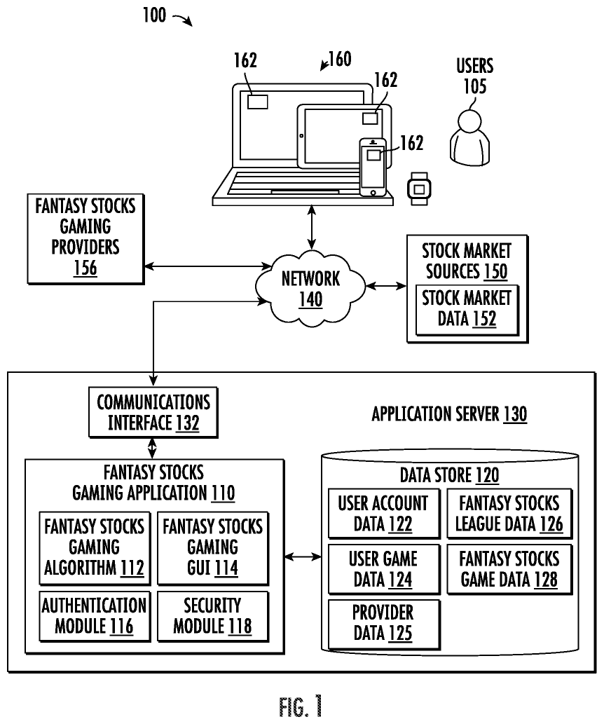

Referring to FIG. 1 illustrates a block diagram of an example of a fantasy investment gaming system 100.

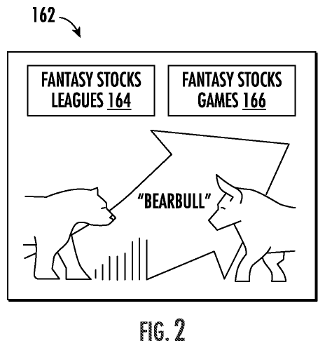

Referring to FIG. 2 illustrates a graphic of an example of a fantasy investment mobile app 162 of the fantasy investment gaming system 100.

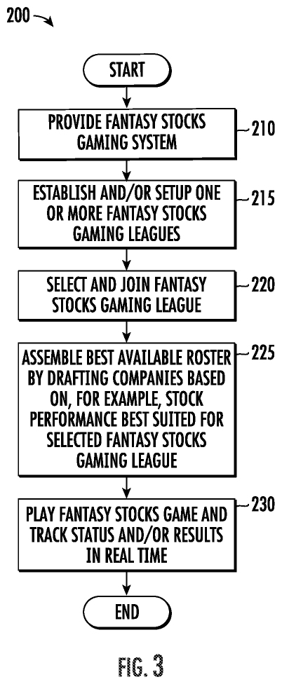

Referring to FIG. 3 illustrates a method 200 of using the fantasy investment gaming system 100.

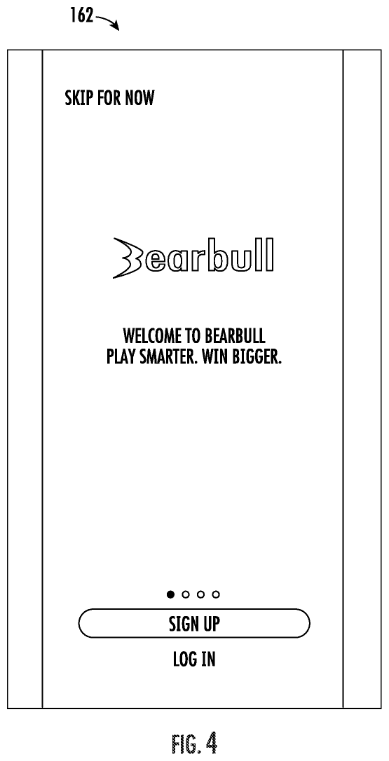

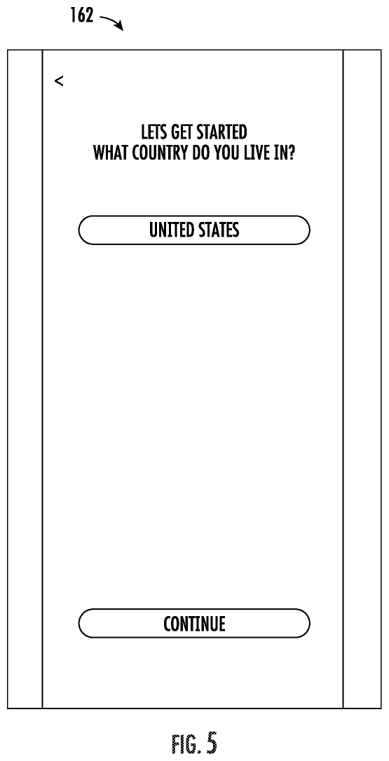

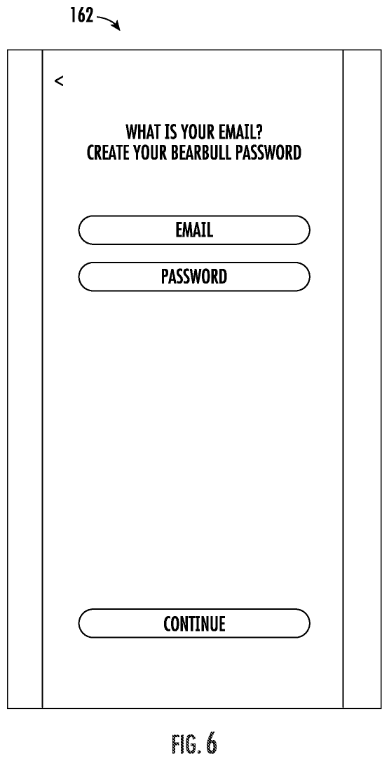

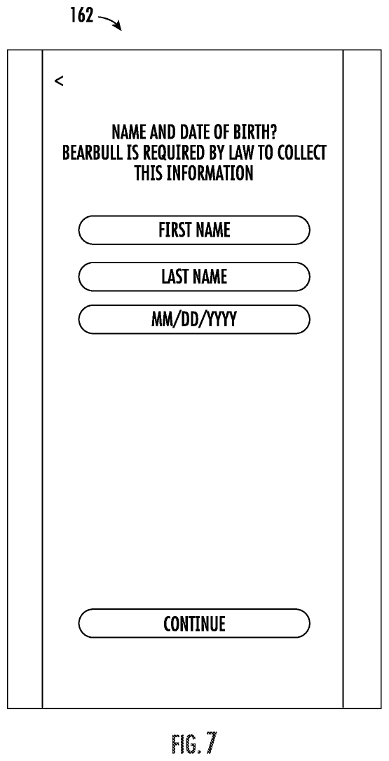

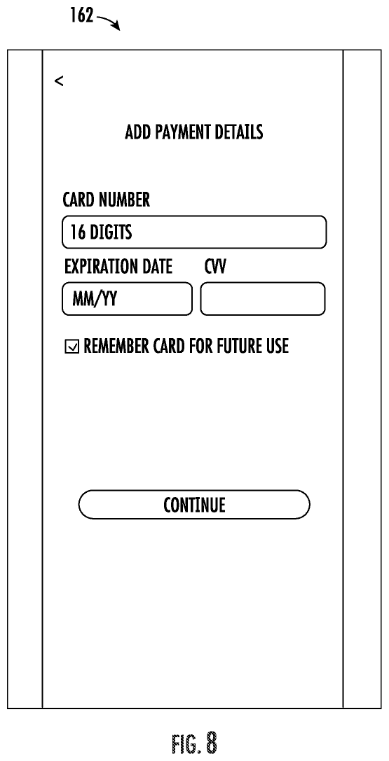

Referring to FIG. 4 through FIG. 8 illustrate example screenshots of example user-sign and user information entry screens of the fantasy investment app 162.

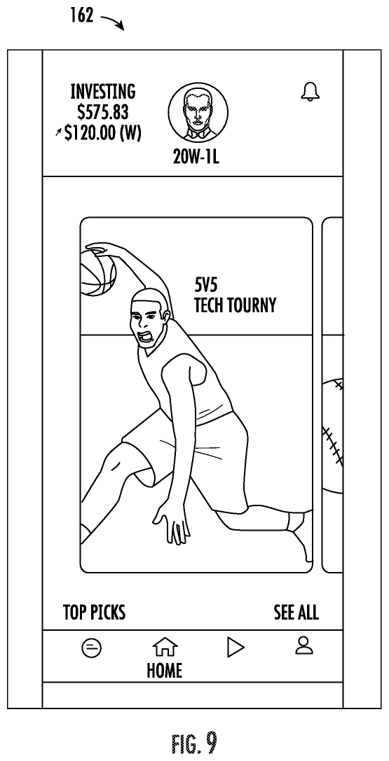

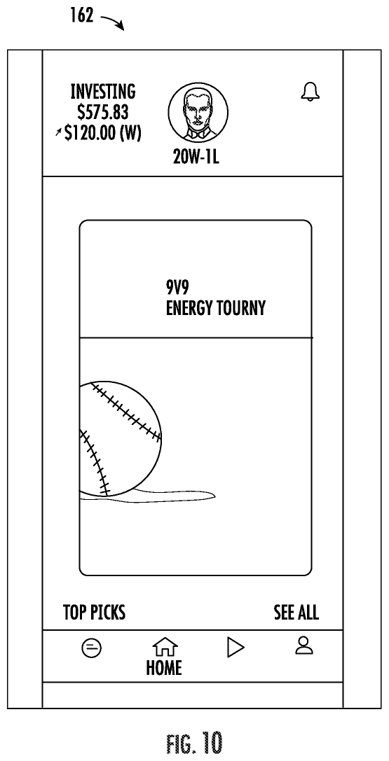

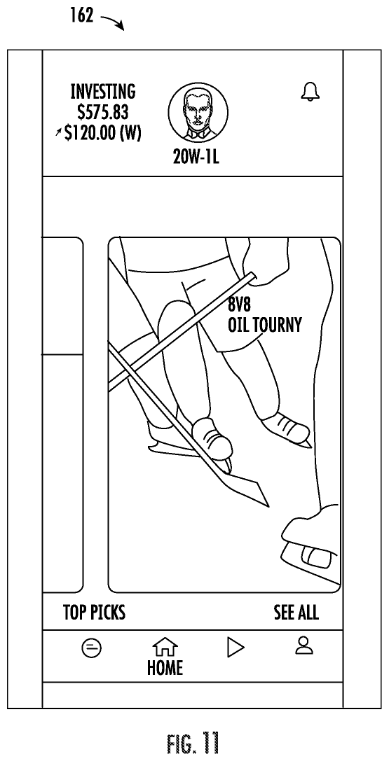

Referring to FIG. 9 through FIG. 11 illustrate example screenshots of example screens from a user's account of the fantasy investment app 162.

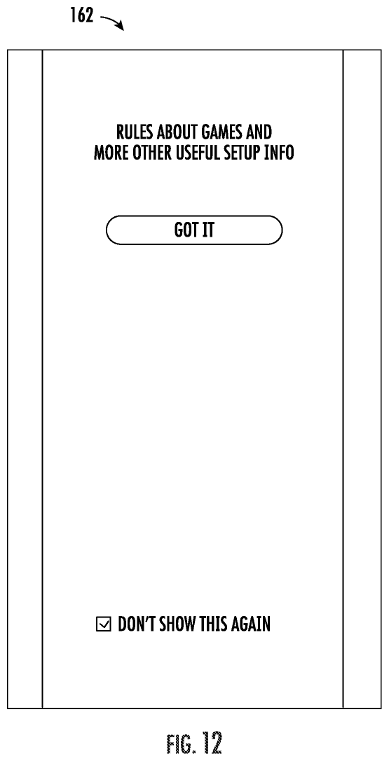

Referring to FIG. 12 illustrates another example screenshot of the fantasy investment app 162 showing an example screen for accessing game rules and setup information.

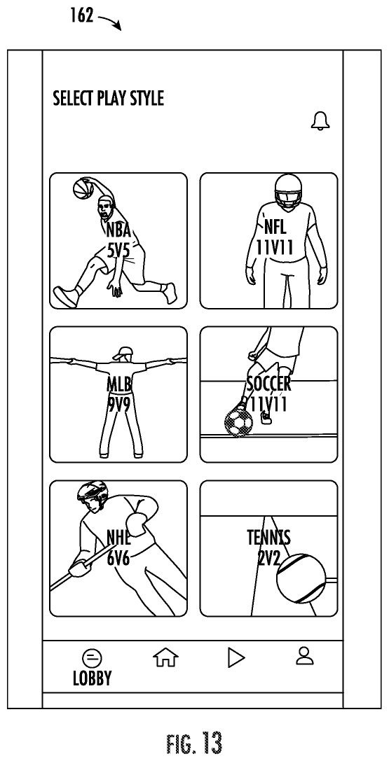

Referring to FIG. 13 illustrates another example screenshot of the fantasy investment app 162 showing a non-limiting example of play styles a user 105 may select from.

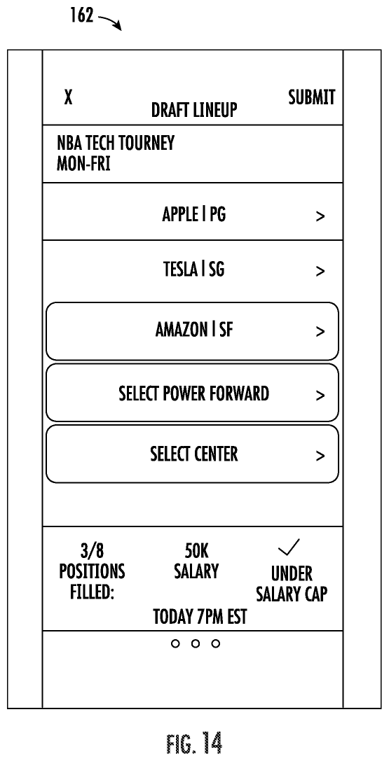

Referring to FIG. 14 illustrates another example screenshot of the fantasy investment app 162 showing a non-limiting example of a user's 105 company draft lineup.

Referring again to FIG. 1 is a block diagram of an example of a fantasy investment gaming system 100, in accordance with an embodiment of the invention. In this example, fantasy investment gaming system 100 may be provided in a networked computing configuration that includes a fantasy investment gaming application 110 and a data store 120 running on an application server 130.

At application server 130, fantasy investment gaming application 110 may further include fantasy investment gaming algorithm 112, a fantasy investment gaming graphical user interface (GUI) 114, an authentication module 116, and a security module 118. Further, user account data 122, user game data 124, provider data 125, fantasy investment league data 126, and fantasy investment game data 128 may be stored at data store 120. Additionally, application server 130 may be accessible via a network 140. Network 140 may be, for example, a local area network (LAN) and/or a wide area network (WAN) for connecting to the Internet or to an Intranet. Application server 130 may connect to network 140 by any wired and/or wireless means. Application server 130 may include, for example, a communications interface 132.

A plurality of users 105 may be associated with the fantasy investment gaming system 100. In fantasy investment gaming system 100, users 105 may be players and/or competitors that are using fantasy investment gaming application 110 to join fantasy investment leagues and to play fantasy investment games. The users 105 may access fantasy investment gaming application 110 at application server 130 via their respective user computers 160 and network 140. User computers 160 may be any computing device, such as, but not limited to, a desktop computer, a laptop computer, a handheld computing device, a mobile phone (or smart phone), a tablet device, a smartwatch, and/or the like. Any information about users 105 may be stored in user account data 122 and/or user game data 124 at data store 120 of application server 130. For example, a user profile for each user 105 in user account data 122 may include, for example, account information, user name, user group name, user/group credentials, user payment information, and/or the like.

A fantasy investment desktop application 162 or fantasy investment mobile app 162 may be installed and running on each of the user computers 160. Fantasy investment desktop application 162 and fantasy investment mobile app 162 is hereafter called fantasy investment app 162.

In one example, users 105 may interact with the fantasy investment gaming application 110 using fantasy investment gaming GUI 114 at application server 130. In this example, fantasy investment gaming GUI 114 may be a web-based GUI that is accessible via network 140. For example, fantasy investment gaming application 110 at application server 130 may be a software application that may be implemented as a web application and run in a web browser, such as Google Chrome, Microsoft Edge, or other web browser.

In another example, users 105 may interact with the fantasy investment gaming application 110 using fantasy investment app 162 of their user computer 160. In this example, fantasy investment app 162 may be implemented, for example, as a .NET application, a desktop application, a mobile app, an application program interface (API), and/or the like. When configured as a mobile app, fantasy investment app 162 may be designed to operate on any device platform, including for example, Windows, Android, Apple, and/or the like.

For example, FIG. 2 shows an example graphic of an example of a fantasy investment app 162, which may be a mobile app of fantasy investment gaming system 100. In this example, fantasy investment app 162 may be used to access one or more fantasy investment leagues 164 in order to play one or more fantasy investment games 166. In one non-limiting example, an example commercial name of the fantasy investment app 162 may be the “BearBull” app. In this example, the “BearBull” app may be the mobile app of “BearBull,” a fantasy investment gaming provider 156. Any information about fantasy investment leagues 164 may be stored in fantasy investment league data 126 at data store 120 of application server 130. Any information about fantasy investment games 166 may be stored in fantasy investment game data 128 at data store 120 of application server 130.

Referring now again to FIG. 1, fantasy investment gaming system 100 may also include a plurality of financial market sources 150 that may provide financial market data 152. Fantasy investment gaming application 110 at application server 130 may access financial market sources 150 and/or financial market data 152 via network 140. Financial market sources 150 that may be the source financial market data 152 may include any third-party sources, applications, and/or mobile apps, such as, for example, Schwab, SoFi, Thinkorswim, Webull, Personal Capital, Money Patrol, Mint, Morningstar, SigFig Portfolio Tracker, Yahoo! Finance, E*TRADE, NinjaTrader, Moomoo, Investing.com, StockTwits, Real-Time Investment Tracker, Bloomberg, JStock, and/or any other accessible source of financial market data.

Additionally, fantasy investment gaming system 100 may include a plurality of fantasy investment gaming providers 156. Fantasy investment gaming providers 156 may access fantasy investment gaming application 110 via network 140. Fantasy investment gaming providers 156 may be organizers and/or sponsors of fantasy investment leagues 164 and/or fantasy investment games 166. Here, a “provider” may correlate to, as one example, DraftKings in conventional fantasy sports gaming. Any information about fantasy investment gaming providers 156 may be stored in provider data 125 at data store 120 of application server 130. In one non-limiting example, a portion of entry fee payments may go to the provider (e.g., “BearBull” fantasy investment gaming provider 156) as rake revenue.

Authentication module 116 of fantasy investment gaming application 110 may be used to manage the authentication process of users 105 of fantasy investment gaming system 100. For example, when the user 105 signs into the fantasy investment gaming application 110, a standard authentication process may be performed that allows the user 105 to access fantasy investment gaming application 110. User-sign in may occur a number of ways. In one non-limiting example, the user 105 may use a web browser to access fantasy investment gaming GUI 114 of fantasy investment gaming application 110 and enter credentials (e.g., username and password).

In another example, the user 105 may use fantasy investment app 162 of their user computer 160 to enter his/her credentials. In yet another example, the user sign-in process may occur automatically when the user 105 starts fantasy investment app 162. As users 105 are authorized to access fantasy investment gaming system 100, user information may be stored in user account data 122 in data store 120. For example, FIG. 4 through FIG. 8 show screenshots of a non-limiting example of fantasy investment app 162 and the user-sign in process and subsequent entry of user information, such as, but not limited to, country, email address, name, date of birth, payment information, and/or the like.

Security module 118 of fantasy investment gaming application 110 may be used to perform any system security functions with respect to keeping secure the contents of data store 120 and/or any other information with respect to fantasy investment gaming system 100. Security module 118 may use standard security techniques, such as, but not limited to, encryption, secure hashtags (or hash tags), and/or other suitable security techniques and/or methods. Data store 120 may be, for example, data repositories (like databases) and/or flat files that can store data. Further, fantasy investment gaming system 100 is not limited to one data store 120 only. Fantasy investment gaming system 100 may include multiple data stores 120.

Communications interface 132 at application server 130 may be any wired and/or wireless communication interface for connecting to a network (e.g., network 140) and by which information may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols.

Referring still to FIG. 1, fantasy investment gaming system 100 may, in one non-limiting example operate in a client/server computing architecture, which is well known. In this example, fantasy investment gaming application 110 at the application server 130 may be the server component of fantasy investment gaming system 100, while fantasy investment app 162 at each of the user computers 160 may be the client component of fantasy investment gaming system 100. In other words, fantasy investment app 162 at each of the user computers 160 is the counterpart to fantasy investment gaming application 110 at application server 130.

Additionally, application server 130 may be any networked computing configuration as long as it is accessible via network 140 by other entities of fantasy investment gaming system 100, such as users 105, financial market sources 152, and fantasy investment gaming providers 156. For example, fantasy investment gaming system 100, and more particularly the fantasy investment gaming application 110 on application server 130, may support a cloud computing environment. In a cloud computing environment, application server 130 may be the cloud server. Further, fantasy investment gaming application 110 is not limited to running on one application server 130 only. Fantasy investment gaming system 100 may include multiple application servers 130 (or cloud servers) in order to ensure high-availability of computing resources.

Generally, and referring now again to FIG. 1 and FIG. 2, fantasy investment gaming application 110 may be a software application that provides a means of using investment (i.e., companies and/or any other publically tradeable commodities) in a fantasy gaming format that allows players (e.g., users 105) to compete, draft, and manage investment in a game of skill. Fantasy investment gaming algorithm 112 may be used to process all the information generated and/or received by fantasy investment gaming application 110 and thereby manage the overall operations of fantasy investment gaming system 100. As used herein, the term investment, shall be understood to include any publically tradeable company, security, commodity, currency, and/or other investment type; and the term stock or stocks, in addition to its common meaning, shall also be understood to include share(s) and/or other terms commonly used in the public trading of securities, commodities, currencies, and/or other tradable investment types.

Fantasy investment leagues 164 and/or fantasy investment games 166 of fantasy investment gaming system 100 may be structured with a traditional fantasy timeline format (i.e., a season-like format), such as daily gaming, weekly, monthly, quarterly, and yearly “season-like” formats of game length. In one non-limiting example, fantasy investment app 162 may be used to play a daily fantasy investment game 166. In fantasy investment gaming application 110, much like the traditional “season-like” format, daily fantasy investment may be an accelerated variant of traditional fantasy investment that are conducted over short-term periods, such as a week, 3 days, or single day of competition, as opposed to those that are played across, for example, a fiscal/calendar month (#1-12) as well as played across any fiscal/calendar quarter, two quarters, three quarters or an entire fiscal/calendar year.

Fantasy investment gaming application 110 may be constructed using, for example, a company's full name and/or stock tickers. In fantasy investment games 166, using companies and investment in a fantasy gaming format allows players to compete against others, becoming a game of skill to win. For example, fantasy investment games 166 and/or leagues of fantasy investment gaming application 110 may provide a game of skill using 1-on-1 competition and/or multi-players competition. Fantasy investment gaming application 110 may be played, for example, using any publically traded company and/or other publically tradeable investment (for example, but not-limited to, other securities, commodities, currencies). Fantasy investment gaming application 110 may also be used in the short of an investment performance, such as in the short of a company, for competition.

Fantasy investment gaming application 110 may be played as a game of skill, and can be played in various formats. In one example, a fantasy investment format may be a “season-like” fantasy format, and in another example of a fantasy investment format, it may be a “daily” fantasy investment format, which may be a subset of “season-like” fantasy investment competitions/games.

Additionally, during game play, financial market sources 150 may provide financial market data 152 to fantasy investment gaming application 110 to inform the selected fantasy investment league 164 and/or fantasy investment game 166. The financial market data 152 may be pushed and/or pulled to the fantasy investment gaming application 110, e.g., from a third-party provider, and may be an automated or manual process. In one non-limiting example, financial market data 152 may be automatically updated/provided to the fantasy investment gaming application 110 on a continuous/real-time basis, on predetermined scheduled intervals of time, upon a value change of one or more investments (e.g., companies) that are in a drafted lineup of a game (or games) being played, upon the open and/or close of a particular securities exchange, and/or any other predetermined trigger event.

Fantasy investment gaming application 110 provides traditional (“season-like”) fantasy investment games 166 by which players may compete against others by building a team of investments (e.g. companies), which may be based on different markets/verticals that may be random or pre-determined by the “provider” (e.g., fantasy investment gaming providers 156) and earn points based on the actual statistical performance of the investments in real-world evaluations. This statistical performance data (e.g., financial market data 152) may be pulled (or pushed) from the financial market (e.g., securities exchange) and/or authorized 3rd party (e.g., financial market sources 150). The pulling (or pushing) of the statistical performance data (e.g., financial market data 152) may be an automated process or may be a manual process. Scoring (or points) of fantasy investment games 166 may be based on percentages and/or monetary increases and/or decreases of each investment's (e.g., company's) financial (e.g., stock) performance.

In fantasy investment gaming application 110, daily fantasy investment may be structured in the form of paid competitions typically referred to as a “contest.” Winners may receive a prize, in one non-limiting example, the prize may be a monetary award, for example, a share of a pre-determined pot, which, for example, may be funded by their entry fees, or other funding source. In one non-limiting example, a portion of each entry fee payment may go to the fantasy investment game provider 156 (e.g., BearBull) as rake revenue. Here, a “provider” may correlate to, for example, DraftKings in conventional fantasy sports gaming.

In fantasy investment gaming application 110, “value games” may be provided. “Value games”, in this example, may mean drafting rosters using an allotted amount. This amount may be predetermined and purchased by each contestant (e.g., each user 105) to enter the game. For example, a game may require $20 to play. Each contestant uses the $20 to enter the game and assemble the best available roster of 10 investments (e.g., companies). Like other games, the outcome may be determined by the team with the biggest gain or loss over the course of the game.

Fantasy investment gaming application 110 may be similar to fantasy sports except that, instead of drafting players/teams, users 105 are drafting investments (e.g., companies) and the metric used to measure performance may be financial performance (e.g., stock price). In fantasy investment gaming application 110, users 105 are “drafting” investments and competing with other users 105 in a certain fantasy investment league 164, and instead of measuring the players stats as in fantasy football, for example, the investment's financial performance (e.g., company's stock performance) may be measured as its metric. The process of drafting investments would be a similar process as would be done for sports players, but using the investments instead.

In one example, with reference to FIG. 13, a user 105 may select a particular play style format associated with a particular sport and user 105 may select a play style format of, for example, but not limited to, NBA 5 v. 5, NFL 11 v. 11, MLB 9 v. 9, soccer 11 v. 11, NHL 6 v. 6, Tennis 2 v. 2. In one non-limiting example, and using the NBA 5 v. 5 example, a user's drafted line-up of five (5) companies would compete against another user's drafted line-up of five (5) companies. In such an example, a user's drafted line-up could be playing head to head against another user's drafted line-up, or alternatively, in a league play where a user's drafted line-up takes on the drafted line-up of more than one other user, e.g., against the drafted line-ups of multiple other users. However, there could be any other play style formats, and those reference herein are meant to be exemplary only. In a non-limiting example, a user would select a play style in a league or a non-league play. In or out of a league a user may have the ability to decide the play style they would like to join.

By way of example, Table 1, Table 2, Table 3, Table 4, Tables 5A, 5B, and 5C, and Table 6 below show examples of teams, rosters, and/or fantasy investment games 166 of fantasy investment gaming application 110 of an example fantasy investment gaming system 100, where, in this example, the investments are companies and the financial performance is based on the stock performance of the investment companies.

For example, any fantasy investment league 164 may include any number of teams. Table 1 shows an example of a Team 1 that has a roster of four companies, a Team 2 that has a roster of four companies, and a Team 3 that has a roster of four companies. For any given user 105, the roster may be formed by “drafting” investments (e.g., companies) based on the objectives of a certain fantasy investment league 164 that the user 105 has joined and based on the availability of investments (e.g., companies). Further to the example, FIGS. 9-11 and 13-14 show screenshots of examples of using fantasy investment app 162 to select teams, rosters, and/or fantasy investment games 166.

In one embodiment, an investment (e.g., company) may only be drafted into one player's line-up in a particular league. Alternatively, a particular play style may allow for an investment (e.g., company) to be drafted into more than one player's line-up in a particular league. In one example, draft position for users may be randomized, and drafting may occur in a “snake” format, e.g., down and back the draft order. Any other suitable methods and/or techniques may be used to establish draft position and/or order.

TABLE 1
Example team rosters of fantasy investment gaming system 100

| Team 1 | Team 2 | Team 3 |
|---|---|---|
| Company#1 | Company#1 | Company#1 |
| Technology ABC | Entertainment XYZ | Technology XYZ |
| Company#2 | Company#2 | Company#2 |
| Entertainment ABC | Auto XYZ | Food&Bev XYZ |
| Company#3 | Company#3 | Company#3 |
| Auto ABC | Financial XYZ | Oil XYZ |
| Company#4 | Company#4 | Company#4 |
| Financial ABC | Pharma XYZ | Pharma ABC |

Within a fantasy investment league 164, teams may trade investments (e.g., companies) like fantasy sports teams trade players. For example, Table 2 shows that the Team 1, 2, and 3 rosters have changes because of trades made among Team 1, 2, and 3. Table 2 includes the same sixteen companies shown in Table 1, but now assigned to different teams due to trades. In one example, trades may only occur prior to the game starting. In another example, trades may occur anytime or at predetermined times during the game.

TABLE 2
Example team rosters of fantasy investment
gaming system 100 after trade

| Team 1 | Team 2 | Team 3 |
|---|---|---|
| Company#1 | Company#1 | Company#1 |
| Auto XYZ | Pharma ABC | Technology XYZ |
| Company#2 | Company#2 | Company#2 |
| Entertainment ABC | Technology ABC | Food&Bev XYZ |
| Company#3 | Company#3 | Company#3 |
| Oil XYZ | Financial XYZ | Auto ABC |
| Company#4 | Company#4 | Company#4 |
| Financial ABC | Pharma XYZ | Entertainment XYZ |

Referring now to Table 3 is an example of a head-to-head fantasy investment game 166 between a Team 1 and a Team 2. Team 1 and Team 2 have five companies each and wherein the five companies can be any companies of any industry, category, or sector. In this example, the “season” is three days. The competition is based on the net gain or loss in total stock monetary value from the first day to the end of the third day (e.g., market close). The team with the highest net gain wins this fantasy investment game 166. In this example, Team 1 has a net gain/loss of +1 and Team 2 has a net gain/loss of +5. Team 2 is the winner. In another example, the gain/loss can be indicated as a percent gain/loss and then the winner calculated.

TABLE 3
Example team results of fantasy investment gaming system 100

| Team1 | d1 | d2 | d3 | g/l | Team 2 | d1 | d2 | d3 | g/l |
|---|---|---|---|---|---|---|---|---|---|
| Company#1 | 132 | 130 | 134 | +2 | Company#1 | 58 | 57 | 57 | −1 |
| Technology ABC | | | | | Oil XYZ | | | | |
| Company#3 | 181 | 177 | 180 | −1 | Company#2 | 12 | 13 | 11 | −1 |
| Entertainment ABC | | | | | Financial XYZ | | | | |
| Company#3 | 11 | 10 | 11 | 0 | Company#3 | 8 | 8 | 9 | +1 |
| Auto ABC | | | | | Cellular XYZ | | | | |
| Company#4 | 9 | 9 | 10 | +1 | Company#4 | 161 | 162 | 165 | +4 |
| Financial ABC | | | | | Pharma XYZ | | | | |
| Company#5 | 167 | 162 | 166 | −1 | Company#5 | 46 | 49 | 48 | +2 |
| Pharma ABC | | | | | Food&Bev XYZ | | | | |

| | | | |
|---|---|---|---|
| Team 1 Net Gain/Loss | +1 | Team 2 Net Gain/Loss | +5 |

Referring now to Table 4 is an example of a head-to-head fantasy investment game 166 between a Team 1 and a Team 2. Team 1 and Team 2 have five companies each and wherein the five companies of each team are in the same industry, category, or sector. For example, a “technology” company of Team 1 is competing against a different “technology” company of Team 2. An “entertainment” company of Team 1 is competing against a different “entertainment” company of Team 2. An “auto” company of Team 1 is competing against a different “auto” company of Team 2. A “financial” company of Team 1 is competing against a different “financial” company of Team 2. A “pharma” company of Team 1 is competing against a different “pharma” company of Team 2.

In this example, the “season” is three days. The competition is based on winning a category for 1 point each. In this example, Team 1 wins the “technology” and “pharma” categories for 2 points. Team 3 wins the “entertainment” and “auto” and “financial” categories for 3 points. Team 2 is the winner. In another example, for each category, the gain/loss can be indicated as a percent gain/loss and then points awarded.

TABLE 4
Example team results of fantasy investment gaming system 100

| Team 1 | d1 | d2 | d3 | g/l | Team 2 | d1 | d2 | d3 | g/l |
|---|---|---|---|---|---|---|---|---|---|
| Company#1 | 132 | 130 | 134 | +2 | Company#1 | 96 | 95 | 96 | 0 |
| Technology ABC | | | | | Technology XYZ | | | | |
| Company#2 | 181 | 177 | 180 | −1 | Company#2 | 214 | 216 | 215 | +1 |
| Entertainment ABC | | | | | Entertainment XYZ | | | | |
| Company#3 | 11 | 10 | 11 | 0 | Company#3 | 149 | 152 | 155 | +6 |
| Auto ABC | | | | | Auto XYZ | | | | |
| Company#4 | 9 | 9 | 10 | +1 | Company#4 | 82 | 82 | 84 | +2 |
| Financial ABC | | | | | Financial XYZ | | | | |
| Company#5 | 167 | 162 | 166 | −1 | Company#5 | 39 | 38 | 36 | −3 |
| Pharma ABC | | | | | Pharma XYZ | | | | |

| | | | |
|---|---|---|---|
| Team 1 Categories Won | 2 | Team 2 Categories Won | 3 |

Referring now to Tables 5A, 5B, and 5C is an example of a head-to-head fantasy investment game 166 between a Team 1, a Team 2, and a Team 3. Teams 1, 2, and 3 have four companies each. In this example, the “season” is one quarter (e.g., 2021 Q1). The competition is based on the aggregate percent gain or loss in total stock value from the first day to the last day of the quarter. The team with the highest aggregate gain wins this fantasy investment game 166. In this example, Table 5A shows Team 1 has an aggregate percent loss of −3.4. Table 5B shows Team 2 has an aggregate percent gain of +1.5. Table 5C shows Team 3 has an aggregate percent gain of +1.9. Team 3 is the winner.

TABLE 5A
Example team results of fantasy investment gaming system 100

| | 1^{st} Quarter 2021 | | |
|---|---|---|---|
| | Starting day | Ending day | |
| Team 1 | stock price | stock price | % gain/loss |
| Company#1 | 132 | 111 | −16.0 |
| Technology ABC | | | |
| Company#2 | 181 | 189 | +4.4 |
| Entertainment ABC | | | |
| Company#3 | 11 | 13.5 | +22.7 |
| Auto ABC | | | |
| Company#4 | 9 | 8.2 | −9.0 |
| Financial ABC | | | |
| Totals | 333 | 321.7 | |

| | |
|---|---|
| Aggregate % gain/loss | −3.4 |

TABLE 5B
Example team results of fantasy investment gaming system 100

| | 1^{st} Quarter 2021 | | |
|---|---|---|---|
| | Starting day | Ending day | |
| Team 2 | stock price | stock price | % gain/loss |
| Company#1 | 214 | 218 | +1.8 |
| Entertainment XYZ | | | |
| Company#2 | 149 | 141 | −5.4 |
| Auto XYZ | | | |
| Company#3 | 82 | 89 | +8.5 |
| Financial XYZ | | | |
| Company#4 | 39 | 43.5 | +11.5 |
| Pharma XYZ | | | |
| Totals | 484 | 491.5 | |

| | |
|---|---|
| Aggregate % gain/loss | +1.5 |

TABLE 5C
Example team results of fantasy investment gaming system 100

1^{st} Quarter 2021

| | Starting day | Ending day | |
|---|---|---|---|
| Team 3 | stock price | stock price | % gain/loss |
| Company#1 | 96 | 101 | +5.2 |
| Technology XYZ | | | |
| Company#2 | 46 | 39 | −15.3 |
| Food&Bev XYZ | | | |
| Company#3 | 58 | 55 | −5.2 |
| Oil XYZ | | | |
| Company#4 | 167 | 179 | +7.1 |
| Pharma ABC | | | |
| Totals | 367 | 374 | |

| | |
|---|---|
| Aggregate % gain/loss | +1.9 |

In another example, a fantasy investment game 166 may be designed for players to compete within one industry, category, or sector only. For example, each player may have a roster of all “oil” companies, all “auto” companies, all “technology” companies, and so on. For example, Table 6 is an example of a head-to-head fantasy investment game 166 between a Team 1 and a Team 2. Team 1 has a roster of five “auto” companies and Team 2 has a roster of five different “auto” companies. In this example, the “season” is three days. The competition is based on the net gain or loss in total stock monetary value from the first day to the end of the third day. The team with the highest net gain wins this fantasy investment game 166. In this example, Team 1 has a net gain/loss of +1 and Team 2 has a net gain/loss of +6. Team 2 is the winner. In another example, the gain/loss can be indicated as a percent gain/loss and then the winner calculated.

TABLE 6
Example team results of fantasy investment gaming system 100

| Team 1 | d1 | d2 | d3 | g/l | Team 2 | d1 | d2 | d3 | g/l |
|---|---|---|---|---|---|---|---|---|---|
| Company#1 | 181 | 177 | 180 | −1 | Company#1 | 149 | 152 | 155 | +6 |
| Auto AB | | | | | Auto LM | | | | |
| Company#2 | 9 | 9 | 10 | +1 | Company#2 | 39 | 38 | 36 | −3 |
| Auto CD | | | | | Auto NP | | | | |
| Company#3 | 167 | 162 | 166 | −1 | Company#3 | 214 | 216 | 215 | +1 |
| Auto EF | | | | | Auto QR | | | | |
| Company#4 | 11 | 10 | 11 | 0 | Company#4 | 96 | 95 | 96 | 0 |
| Auto GH | | | | | Auto ST | | | | |
| Company#5 | 132 | 130 | 134 | +2 | Company#5 | 82 | 82 | 84 | +2 |
| Auto JK | | | | | Auto UV | | | | |

| | | | |
|---|---|---|---|
| Team 1 Net Gain/Loss | +1 | Team 3 Net Gain/Loss | +6 |

Additionally, fantasy investment games 166 of fantasy investment gaming application 110 of fantasy investment gaming system 100, such as those shown in Table 1 through Table 6, may be based on the “short” of a game. The “short” of the game means the team that has the largest decrease in value in comparison to the highest growth in value/score.

Referring now to FIG. 3 is a flow diagram of an example method 200 of using fantasy investment gaming system 100 shown in FIG. 1, in accordance with an embodiment of the invention. Method 200 may include, but is not limited to, the following steps, and is not limited to a particular order of steps.

At a step 210, a fantasy investment gaming system is provided. For example, fantasy investment gaming system 100 that may include fantasy investment gaming application 110 as described hereinabove with reference to FIG. 1 and FIG. 2 is provided.

At a step 215, one or more fantasy investment gaming leagues are established and/or setup. For example, one or more fantasy investment gaming providers 156 may establish and/or setup one or more fantasy investment leagues 164 that users 105 may join to play fantasy investment games 166. In one example, users 105 may view rules about games using fantasy investment app 162, as shown, for example, in FIG. 12.

At a step 220, a fantasy investment gaming league is selected and joined. For example, using fantasy investment app 162 at his/her user computer 160, a user 105 may log into fantasy investment gaming application 110. Then, the user 105 may browse the available fantasy investment leagues 164. Then, the user 105 may select and join a certain fantasy investment league 164. Then, the user 105 may pay an entry fee if required.

At a step 225, user's rosters are assembled by drafting investments (e.g., companies) based on, for example, the financial (e.g., stock) performance the user believes is best suited for the selected fantasy investment gaming league and play style. For example, using fantasy investment app 162, a user 105 may assemble what they believe is the best available roster by drafting investments (e.g., companies) based on, for example, the financial (e.g., stock) performance the user believes is best suited for the selected fantasy investment league 164. In one example, users 105 may use fantasy investment app 162 to assemble their rosters, as shown in FIGS. 9-11 and 13-14. For example, Table 1 shows an example of a roster selected by a user 105 (or team). Further, Table 2 shows an example of a roster after trades have been made between users 105 (or teams). In one example, trades may only occur prior to the game starting. In another example, trades may occur anytime or at predetermined times during the game.

At a step 230, a fantasy investment game is played, while the status and/or results is tracked in real time. For example, a user 105 plays a certain fantasy investment game 166. Using fantasy investment app 162, a user 105 may track in real time the status and/or results of the fantasy investment game 166. Again, see fantasy investment app 162 shown in FIGS. 9-11 and 13-14. Scoring (or points) of the fantasy investment game 166 may be based, for example, on percentages and/or monetary increases and decreases of each investment's (e.g., company's) financial (e.g., stock) performance. Accordingly, during game play, financial market sources 150 may automatically provide financial market data 152 to fantasy investment gaming application 110, in real time, to inform the fantasy investment game 166.

In summary and referring now again to FIG. 1 through FIG. 14, a main component of fantasy investment gaming system 100, fantasy investment gaming application 110, and/or method 200 may be the use of investments (e.g. companies) and financial performance in fantasy gaming.

Further, key differentiators of fantasy investment gaming system 100, fantasy investment gaming application 110, and/or method 200 compared with conventional fantasy sports gaming may include, but are not limited to, the following:
Financial Performance vs Player Performance;
Investments (e.g., companies) “Drafted” vs Players/People “Drafted”;
Sum of Percentages/Profits/Losses vs Sum of Points/player stats;
In Season-Like Formats/Fiscal Dates vs Team Schedule Dates;
A player or contestant can win by having lowest percentage/points earned in a given timeframe of their contest (e.g., short); and
Fantasy sports are not based on the “short” of a game, but instead the player/team with highest points earned.

Further, certain benefits of fantasy investment gaming system 100, fantasy investment gaming application 110, and/or method 200 may include, but are not limited to, (1) to bring interest in the financial markets to the individuals who typically do not invest, but do perhaps play fantasy games, and vice versa; (2) to bridge the gap between the financial market and fantasy gaming; (3) to enable individuals to be invested in the financial market without actually having their money in the financial market; and (4) to disrupt the market of fantasy sports and/or the financial market, and thereby create economical changes.

Further, although fantasy investment gaming system 100, fantasy investment gaming application 110, and/or method 200 have been described in the context of fantasy gaming, fantasy investment gaming system 100, fantasy investment gaming application 110, and/or method 200 may be utilized in other applications. For example, fantasy investment gaming system 100, fantasy investment gaming application 110, and/or method 200 may be effective in other gaming methods, such as online gaming and casino gaming.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A fantasy investment gaming system, comprising:
a. a memory configured to store a set of instructions; and
b. a processor configured to execute the set of instructions, the set of instructions comprising:
i. generating one or more fantasy investment gaming leagues;
ii. providing access to the one or more fantasy investment gaming leagues to a plurality of authorized users, wherein each of the authorized users selects at least one of the one or more fantasy investment gaming leagues to join;
iii. generating and providing one or more lists of available investments to the plurality of authorized users, wherein the one or more lists of available investments are based on the selected one or more fantasy investment gaming leagues joined by the plurality of authorized users, and wherein each of the authorized users select a fantasy lineup comprising one or more investments from the one or more lists of available investments corresponding to the one or more fantasy investment gaming leagues they joined;
iv. automatically receiving and tracking market data of the selected available investments from at least one market data source over a predetermined time period;
v. analyzing the market data; and
vi. determining, at the end of the predetermined time period, for each of the one or more fantasy investment gaming leagues, which of the selected fantasy lineups performed the best based on a predefined criteria over the predetermined time period.

2. The system of claim 1, wherein the market data comprises financial market data.

3. The system of claim 1, wherein the market data is automatically provided to the fantasy investment gaming system at predetermined time intervals by the market data source.

4. The system of claim 1, wherein during the predetermined time period the performance of each of the selected fantasy lineups is automatically updated in real-time based on the received market data and compared, based on the predefined criteria, to the other selected fantasy lineups within its fantasy investment gaming leagues.

5. The system of claim 4, wherein the authorized users can monitor the performance of their selected fantasy lineups in real-time during the predetermined time period.

6. The system of claim 1, wherein the market data is automatically provided by the at least one market data source to the fantasy investment gaming system in real-time.

7. The system of claim 1, wherein the available investments comprise one or more of publically traded securities, commodities, and currencies.

8. The system of claim 1, wherein the available investments comprise publically traded companies.

9. The system of claim 1, wherein the predefined criteria comprises financial performance of the investments of the selected fantasy lineups.

10. A method of conducting a fantasy investment game, the method comprising:
a. generating one or more fantasy investment gaming leagues;
b. providing access to the one or more fantasy investment gaming leagues to a plurality of authorized users;
c. selecting by the plurality of authorized users at least one of the one or more fantasy investment gaming leagues to join;
d. generating and providing one or more lists of available investments to the plurality of authorized users, wherein the one or more lists of available investments are based on the selected one or more fantasy investment gaming leagues joined by the plurality of authorized users, and wherein each of the authorized users select a fantasy lineup comprising one or more investments from the one or more lists of available investments corresponding to the one or more fantasy investment gaming leagues they joined;
e. receiving and tracking market data of the selected available investments from at least one market data source over a predetermined time period;
f. analyzing the market data; and
g. determining at the end of the predetermined time period, for each of the one or more fantasy investment gaming leagues, which of the selected fantasy lineups performed the best based on a predefined criteria over the predetermined time period.

11. The method of claim 10, wherein the market data comprises financial market data.

12. The method of claim 10, wherein the market data is automatically provided to the fantasy investment gaming system at predetermined time intervals by the market data source.

13. The method of claim 10, wherein the market data is automatically provided by the at least one market data source to the fantasy investment gaming system in real time.

14. The method of claim 10, wherein the available investments comprise one or more of publically traded securities, commodities, and currencies.

15. The method of claim 10, wherein the available investments comprise publically traded companies.

16. The method of claim 10, wherein the predefined criteria comprises financial performance of the investments of the selected fantasy lineups.

17. The method of claim 10, wherein during the predetermined time period the performance of each of the selected fantasy lineups is automatically updated in real-time based on the received market data and compared, based on the predefined criteria, to the other selected fantasy lineups within its fantasy investment gaming leagues.

18. The method of claim 17, wherein the authorized users can monitor the performance of their selected fantasy lineups in real-time during the predetermined time period.
